(19) United States
(12) Patent Application Publication
(10) Pub. No.: US 2018/0099406 A1
(43) Pub. Date: Apr. 12, 2018

(54) Device for Three-dimensionally Positioning a Coupling Component and Actuator System

(71) Applicant: Airbus Helicopters Deutschland GmbH, Donauworth (DE)

(72) Inventors: Erik BORMANN, Darmstadt (DE); Martin LEHMANN, Darmstadt (DE); Maximilian MOHR, Neumarkt (DE); Tim ROSER, Donauworth (DE); Sebastian BUESING, Augsburg (DE); Christian WOLF, Neu-Ulm (DE)

(21) Appl. No.: 15/726,150

(22) Filed: Oct. 5, 2017

(30) Foreign Application Priority Data
Oct. 5, 2016 (DE) 102016219260.4

(51) Int. Cl. B25J 9/00; B25J 9/10; B25J 9/14; B25J 9/12; B25J 13/08; B25J 17/02

(52) U.S. Cl. CPC B25J 9/0072; B25J 9/0009; B25J 9/106; B25J 9/144; B25J 17/0275; B25J 13/085; B25J 13/088; B25J 17/0241; B25J 9/12

(57) ABSTRACT

The invention pertains to a device for 3-dimensionally positioning a coupling component, which forms part of an actuator-driven coupling structure, wherein said device comprises at least a first coupling element that extends in a first longitudinal direction and can be bidirectionally displaced along its first longitudinal direction by means of a first actuator, a second coupling element that extends in a second longitudinal direction and can be bidirectionally displaced along its second longitudinal direction, which extends orthogonal to the first longitudinal direction, by means of a second actuator, and a lever with a longitudinal lever direction that is mounted pivotably about a pivoting axis, which divides the lever into a work arm and a power arm. The longitudinal lever direction of the lever either extends along the first longitudinal direction and its work arm is on its end fixed on the second coupling element such that it can be pivoted about the second longitudinal direction or the longitudinal lever direction of the lever extends along the second longitudinal direction and its work arm is on its end fixed on the first coupling element such that it can be pivoted about the first longitudinal direction. Furthermore the power arm of the lever is functionally connected to a third actuator in such a way that a torque, which acts upon the lever about the pivoting axis, can be generated.

### TECHNICAL FIELD

The invention pertains to a device for 3-dimensionally positioning a coupling component that forms part of an actuator-driven coupling structure.

### PRIOR ART

Classical positioning systems of the aforementioned type consist of motor-driven multiaxial positioning systems, which usually allow a position-resolved linear displacement along three spatial axes extending orthogonal to one another. The end effector to be positioned is designed differently depending on the intended use of the respective positioning system, e.g. in the form of a gripper, an individually designed functional interface, a sensor or a machining tool, to name just a few examples.

Conventional linear displacement positioning systems represent, e.g., compound tables or so-called x-y tables that can be additionally displaced along the direction in space extending orthogonal to the x-y plane in order to realize a three-dimensional positioning process.

Positioning systems with spatially maximal degrees of freedom, which in addition to linear displacements also allow rotational motions, represent multiaxial industrial robots, e.g. in the form of so-called gantry robots, which are capable of undertaking a wide variety of positioning tasks.

The shape and design of actuator-assisted positioning systems are customarily adapted to the individual requirements of the respective positioning tasks to be accomplished. For example, an end effector of a positioning system has to be respectively positioned at multiple mechanical connecting or coupling points of a structural component, which spatially lie closely adjacent to one another, e.g., in order to detect deformations of the structural component in the form of displacement changes in a highly precise fashion at each connecting or coupling point. Furthermore, it should alternatively or additionally be possible to locally apply dynamic or static forces on the structural component or to correspondingly absorb and sensorially detect such forces by means of the three-dimensional positioning system at the location of the respective connecting or coupling points

Conventional industrial robot systems, the end effector of which can be respectively positioned in a force-controlled and path-controlled fashion and therefore displaced, are basically available for this purpose. However, if highly precise positioning processes have to be respectively carried out with a separate industrial robot at a plurality of connecting points of a structural component, which spatially lie closely adjacent to one another, it not only has to be taken into account that the floor space required for accommodating the industrial robots adjacent to the structural component is limited, but that such systems are also uneconomical due to the required number of such cost-relevant industrial robots.

Publication US 2008/0202274 A1 describes a manipulator system that is suitable for medical applications and consists of at least three actuators, which are connected to a body and capable of moving or positioning the body independently of one another by at least one spatial degree of freedom.

Publication WO 2009/049654 A1 discloses a motion system for carrying out relative motions between a kinematic input element and an output element, between which a plurality of coupling elements are arranged.

Publication U.S. Pat. No. 6,425,303 B1 describes a comparable kinematic system between a base component and a final component that can be positioned relative thereto.

### DISCLOSURE OF THE INVENTION

The invention is based on the objective of realizing a device for three-dimensionally positioning a coupling component in the form of an end effector, which forms part of an actuator-driven coupling structure, in such a way that the coupling component can be precisely positioned in space, i.e. with an accuracy of at least ±0.1 mm, preferably ±0.01 mm, along all three spatial axes extending orthogonal to one another. The device should furthermore have a robust and stable design such that it is capable of respectively generating and absorbing actuating forces of up to 50 kN at the location of the coupling component. The device should have the most compact structural design possible in order to thereby allow the combination with a plurality of structurally identical devices and to assemble a compound stack, by means of which a plurality of respectively actuator-driven and positionable coupling components, which spatially lie closely adjacent to one another, can be realized. The spatial distance between two respectively adjacent coupling components should be as small as approximately 200 mm.

The objective of the invention is attained with the characteristics disclosed in claim 1. Characteristics that advantageously enhance the inventive concept form the objects of the dependent claims and can be gathered from the following description of exemplary embodiments.

According to the invention, the device for three-dimensionally positioning a coupling component, which forms part of an actuator-driven coupling structure, is characterized by the following components: at least one first coupling element extending in a first longitudinal direction is mounted such that it can be bidirectionally displaced along its first longitudinal direction by means of a first actuator. In addition, at least one second coupling element extending in a second longitudinal direction is mounted such that it can be bidirectionally displaced along its second longitudinal direction by means of a second actuator, wherein the second longitudinal direction extends orthogonal to the first longitudinal direction. Furthermore, a lever extending in a longitudinal lever direction is provided and mounted pivotably about a pivoting axis, which divides the lever into a work arm and a power arm.

In a first inventive design variation, the longitudinal lever direction extends along the first longitudinal direction of the first coupling element, wherein the work arm of the lever is on its end fixed on the second coupling element such that it can be pivoted about the second longitudinal direction.

In a second inventive design variation, the longitudinal lever direction extends along the second longitudinal direction of the second coupling element, wherein the work arm of the lever is on its end fixed on the first coupling element such that it can be pivoted about the first longitudinal direction.

In both alternative inventive designs, the power arm of the lever is functionally connected to a third actuator in such a way that a torque, which acts upon the lever about the pivoting axis, can be generated.

The advantageous appeal of the device for three-dimensionally positioning an actuator-driven coupling structure can be seen in that the first and the second coupling element, as well as the lever, are in a starting position preferably arranged in a common plane and only have a small structural height orthogonal to this plane.

In a preferred design variation, the first and the second actuator are furthermore arranged in a common plane such that all components for the bidirectional displacement of the coupling component along the first and the second longitudinal direction lie in the plane defined by the first and the second coupling element. Only the third actuator, which serves for generating the torque acting upon the power arm of the lever, is arranged outside this plane and has an effective actuator direction that is directed at the power arm and includes an angle a with the aforementioned common plane, wherein 0°<α<90°, preferably 20°≦α≦65°, particularly 35°≦α≦55°, applies to said angle. Due to the angled alignment of the third actuator or the effective actuator direction of the third actuator relative to the common plane, it is possible to respectively stack structurally identical inventive devices orthogonal to the common plane as described in greater detail further below in order to three-dimensionally position a plurality of separate coupling components.

The coupling component of the coupling structure to be positioned is advantageously, but not necessarily, arranged along the first and/or the second longitudinal direction. In this way, the tensile forces and/or compressive forces acting axially along the first and/or the second coupling component can be transmitted without loss.

All actuators are respectively realized in the form of linear actuators, namely in the form of a servo motor, a stepping motor, a hydraulic cylinder unit or a pneumatic cylinder unit depending on the intended use. The three actuators do not necessarily have to be designed identically, wherein the aforementioned linear actuators may in conceivable applications by all means be used in any combination with one another.

In a preferred embodiment, the first actuator is arranged relative to the first coupling element in such a way that its effective actuator direction extends parallel to the longitudinal direction of the first coupling element. The second actuator is analogously arranged relative to the second coupling element in such a way that its effective actuator direction extends parallel to the second longitudinal direction. Depending on the available structural space and the respectively available actuators, it may be possible to connect the first actuator directly to the first coupling element in the longitudinal direction and to analogously connect the second actuator directly to the second coupling element along the second longitudinal direction.

Both coupling elements are preferably realized in the form of rigid longitudinal bodies, e.g. in the form of a rod, a tube or a longitudinal profile.

The above-described serial arrangement of the first and the second actuator along the first and the second coupling element may be realized as long as no excessively high actuating forces have to be respectively generated or absorbed for positioning purposes.

In another preferred embodiment, which is suitable for respectively generating or absorbing high actuating forces at the location of the coupling component to be positioned, the first actuator is connected to the first coupling element by means of a first power transmission mechanism. The second actuator is alternatively or additionally connected to the second coupling element by means of a second power transmission mechanism. In both instances, it is preferred that the power transmission mechanisms are respectively realized in the form of a mechanical lever, which is supported on a fixed mechanical thrust bearing and mechanically transmits the actuator forces with a correspondingly chosen lever arm ratio.

Analogous to the first and the second actuator, one side of the third actuator is also supported on a fixed bearing. In contrast to the two other actuators, however, the third actuator is along its effective actuator direction connected to the power arm of a lever, the pivoting axis of which is likewise supported on a fixed bearing.

A linear guide, which varies the length of the work arm, is arranged along the work arm of the lever, wherein a displacement of the coupling element in a direction extending largely orthogonal to the plane defined by the first and the second coupling element can be initiated by changing the length of the work arm and by pivoting the work arm relative to the pivoting axis.

The coupling component to be exactly positioned, which is preferably arranged along the first and/or the second coupling element, is mounted in a rotationally rigid fashion about the first longitudinal direction, as well as about the second longitudinal direction. In the concrete exemplary embodiment described below, the mechanical decoupling from a rotation at the location of the coupling component along the first and the second longitudinal direction can be realized by means of suitably designed and arranged ball joints and/or cardan joints.

A separate position determination device is arranged in the region of the coupling component in order to exactly determine the position at the location of the coupling component. The position determination device generates position signals, which are fed to an actuator control unit in order to respectively activate the three actuators.

Due to the compact design and arrangement of all device components other than the third actuator in a common plane, which is hereafter also referred to as device plane, the prerequisite for the stackability of a number of inventive devices on top of one another is fulfilled, wherein at least two inventive devices with device planes, which are respectively aligned parallel to one another, are arranged spaced apart from one another.

Such a stacked assembly, which preferably consists of a plurality of separate devices that are arranged on top of one another and do not necessarily have to be equidistantly spaced apart from two adjacent device planes, makes it possible to arrange a plurality of coupling components in the immediate vicinity of one another, wherein the spatial positions of these coupling components respectively can be exactly determined and said coupling components can be functionally connected to corresponding connecting or coupling points of a structural component to be analyzed separately from one another.

Potential applications of the inventive actuator system concern testing machines for planar structural components such as aircraft components, particularly in the form of airframes, on which forces of up to 50 kN have to be respectively applied or absorbed at a plurality of connecting points. For this purpose, the individual coupling components preferably have to be respectively displaced in all three directions in space by an actuating stroke of ±20 mm or more.

Publication US 2008/0202274 A1 describes a manipulator system that is suitable for medical applications and consists of at least three actuators, which are connected to a body and capable of moving or positioning the body independently of one another by at least one spatial degree of freedom.

Publication WO 2009/049654 A3 discloses a motion system for carrying out relative motions between a kinematic input element and an output element, between which a plurality of coupling elements are arranged.

Publication U.S. Pat. No. 6,425,303 B1 describes a comparable kinematic system between a base component and a final component that can be positioned relative thereto.

### BRIEF DESCRIPTION OF THE INVENTION

Exemplary embodiments of the invention are described below with reference to the drawings without thereby limiting the general inventive concept. In these drawings:

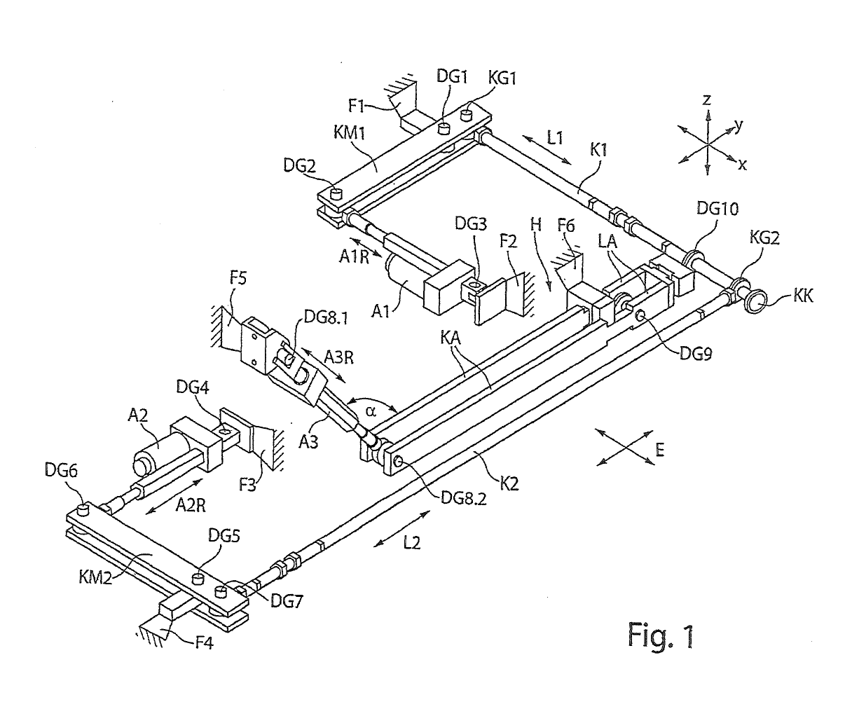

FIG. 1 shows a perspective top view of an inventive coupling structure,

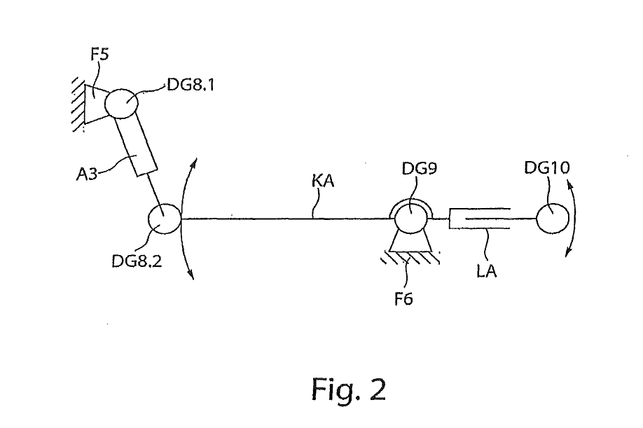

FIG. 2 shows a detail for elucidating a displacement along the z-axis, and

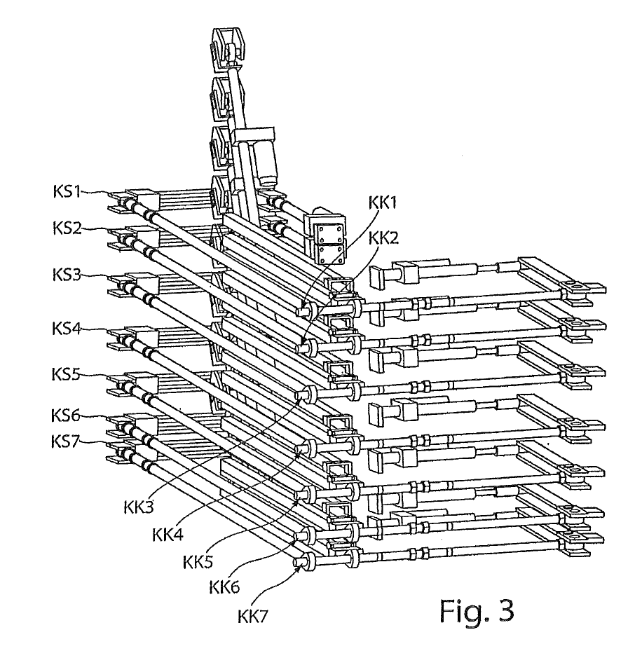

FIG. 3 shows an actuator system comprising a plurality of devices for three-dimensionally positioning a coupling component, which are arranged vertically on top of one another.

### WAYS FOR IMPLEMENTING THE INVENTION; COMMERCIAL APPLICABILITY

FIG. 1 shows a preferred exemplary embodiment for realizing a device for three-dimensionally positioning a coupling component KK that forms part of an actuator-driven coupling structure KS. The further description refers to the coordinate system illustrated in FIG. 1, which is defined by the three spatial axes x, y, z extending orthogonal to one another. The coupling structure KS illustrated in FIG. 1 serves for spatially positioning the coupling component KK arranged on the end of the coupling structure KS in a highly precise fashion. The coupling structure KS is capable of displacing the coupling component KK with a positioning accuracy of up to 0.01 mm and with maximum positioning strokes of up to 30 mm along the three spatial axes. In this case, the coupling structure KS is capable of respectively absorbing or generating loads or forces of up to 50 kN.

The respective actuator-driven axes of the coupling structure KS are described in greater detail below in order to elucidate the displacement of the coupling component KK along the respective spatial axes x, y, z:

1) Positioning the coupling component KK along the x-axis:

An elongate coupling element K1, on one end of which the coupling component KK is arranged, is provided in order to position the coupling component KK along the x-axis in a locally resolved fashion. The first coupling element K1 is preferably realized in the form of a flexural member and connected to a lever arm end of a lever, which forms a first power transmission mechanism KM1, by means of a cardan joint KG1 with its end lying opposite of the coupling component KK. The lever-like power transmission mechanism KM1 is pivotably coupled to a pivot joint DG1, the pivoting axis of which extends orthogonal to the x-y plane E. The pivot joint DG1 is supported on a fixed bearing F1.

A first actuator A1 is coupled to the opposite lever arm end of the power transmission mechanism KM1 by means of a second pivot joint DG2, wherein the effective actuator direction A1R of this first actuator extends parallel to the longitudinal direction L1 of the first coupling element K1, which is realized in the form of a flexural member. The actuator A1 is coupled to a fixed bearing F2 by means of an additional pivot joint DG3.

Due to the pivoted mounting of the power transmission mechanism M1, as well as the cardanic connection of one side of the coupling element K1 in the form of a flexural member, a rotation about the y-axis and the z-axis is permitted at the location of the cardan joint KG1, but a rotation about the x-axis is blocked, i.e. the coupling element K1 in the form of a flexural member is mounted such that it is not only linearly displaceable along the x-axis, but also rotatable about the y-axis and the z-axis.

The actuator force of the first actuator A1 acting along the coupling element K1 in the form of a flexural member can be scaled in a predefined fashion by choosing the lever arm lengths of the power transmission mechanism KM1 accordingly.

A (not-shown) position measuring device, the position measurement signals of which are fed to a not-shown control unit for activating the actuator 1, is preferably arranged in the region of the coupling component KK in order to position the coupling component KK along the x-axis in a locally resolved fashion. The position measuring device and the control unit may consist of commercially available components and therefore do not require a more detailed description at this point.

2) Positioning the coupling component KK along the y-axis:

The displacement of the coupling component KK in the y-direction is realized by means of a second actuator A2, the effective actuator direction A2R of which extends parallel to the longitudinal direction L2 of the second coupling element K2, which is realized in the form of a tension/compression member. The second actuator A2 is supported on a third fixed bearing F3 by means of a pivot joint DG4. The power transmission is realized by means of a second power transmission mechanism KM2 in the form of a lever, which is pivotably coupled to a pivot joint DG5 that in turn is supported on a fourth fixed bearing F4. The second actuator A2 and the second coupling element K2 in the form of a tension/compression member respectively are pivotably coupled to the power transmission mechanism 2 by means of pivot joints DG6 and DG7. At least the pivot joint DG7 is realized in the form of a ball joint. The other end of the second coupling element K2 in the form of a tension/compression member is connected to the first coupling element K1 in the form of a flexural member near the coupling element KK by means of a cardan joint KG2.

Since one side of the second coupling element K2 is mounted on the first coupling element K1 in a cardanic fashion about the x-axis and its end is pivotably connected to the power transmission mechanism KM2 by means of the pivot joint DG7, the second coupling element K2 in the form of a tension/compression member is capable of rotating about the x-axis, as well as about the z-axis. However, rotations about the y-axis are blocked.

A corresponding position measuring device, the position measurement signals of which are fed to a not-shown control unit for activating the second actuator A2, is likewise provided in the region of the coupling component KK in order to position the coupling component KK in the y-direction in a highly precise fashion.

3) Positioning the coupling component KK along the z-axis:

A third actuator A3, which in contrast to all components of the coupling structure KS described so far is arranged outside the plane E, is provided in order to displace the coupling component KK in the z-direction in a locally resolved fashion. The effective actuator direction A3R of the third actuator A3 and the plane E include an angle α, which preferably lies between 20° and 65° , particularly at 45°±10°. In this context, we refer to FIG. 2 as a supplement to FIG. 1.

One side of the third actuator A3 is connected to a fixed bearing F5 by means of a pivot joint DG8.1, which is realized in the form of a cardan joint. The effective actuator end of the third actuator A3 is connected to the power arm KA of the lever H by means of a pivot joint DG8.2, which is realized in the form of a ball joint. The lever H is preferably connected to the fixed bearing F6 by means of a pivot joint DG9, which is realized in the form of a self-contained cardan joint. This can also be gathered from the detail according to FIG. 2. The work arm LA of the lever H is realized in the form of a linear bearing and connected to the first coupling element K1 in the form of a flexural member on the face by means of another pivot bearing DG10, which is realized in the form of a ball joint.

The completely ball-jointed mounting of the lever H, see DG8.1, DG8.2, DG9 and DG10, allows a rotation of the lever about the z-axis. The linear bearing along the work arm LA enables the lever H to follow the motions of the first coupling element K1 in the form of a flexural member in the x-direction, as well as in the y-direction.

A corresponding position measuring device is also arranged in the region of the coupling component KK in this case in order to determine the position of the coupling component KK during motions along the z-axis, wherein the position measurement signals of said position measuring device make it possible to activate the third actuator A3 in a controlled fashion in order to position the coupling component KK in a locally resolved fashion and to realize a purposeful force application.

Furthermore, the three actuators A1, A2, A3 feature corresponding force sensors for respectively measuring the force along the three spatial axes or along their effective actuator directions A1R, A2R, A3R.

FIG. 3 shows a perspective view of an actuator system AS, which consists of a stack-shaped assembly of a plurality of the three-dimensional positioning devices described above. The individual coupling structures KS1, KS2, . . . KS7 are arranged on top of one another in the form of a stack with respectively parallel planes. The ends of all coupling structures KS1, KS2, . . . KS7 illustrated in FIG. 3 respectively feature a coupling component KK1, KK2, KK3, KK4, KK5, KK6 and KK7. The distances between the individual coupling components in the vertical direction of the stack are not necessarily constant, but rather adapted to the local conditions of a not-shown constructional unit.

All structurally and functionally identical components of the coupling structures are arranged on top of one another or slightly offset on top of one another. The actuator system according to FIG. 3 shows the high degree of integrability, which makes it possible to realize a large number of separate coupling components, which are spatially distributed and can be activated and positioned by means of actuators, within a small volume.

### LIST OF REFERENCE SYMBOLS

A1, A2, A3 Actuator
A1R, A2R, A3R Effective actuator direction
D Pivoting axis
DG1, DG2, DG10 Pivot joint
F1, F2, . . . F6 Mechanical fixed bearing
H Lever
K1 First coupling element
K2 Second coupling element
KA Power arm
KG1, KG2 Cardan joint
KK, KK1 . . . KK7 Coupling component
KM1, KM2 Power transmission mechanism
KS, KS1 . . . KS7 Coupling structure
L1, L2 Longitudinal direction
LA Work arm

1. A device for 3-dimensionally positioning a coupling component (KK), which forms part of an actuator-driven coupling structure (KS), comprising at least
a first coupling element (K1) that extends in a first longitudinal direction (L1) and can be bidirectionally displaced along its first longitudinal direction (L1) by means of a first actuator (A1),
a second coupling element (K2) that extends in a second longitudinal direction (L2) and can be bidirectionally displaced along its second longitudinal direction (L2), which extends orthogonal to the first longitudinal direction (L1), by means of a second actuator (A2), and
a lever (H) with a longitudinal lever direction (HL) that is mounted pivotably about a pivoting axis (D), which divides the lever (H) into a work arm (LA) and a power arm (KA), wherein
a) the longitudinal lever direction (HL) of the lever extends along the first longitudinal direction (L1) and its work arm (LA) is on its end fixed on the second coupling element (K2) such that it can be pivoted about the second longitudinal direction (L2) or
b) the longitudinal lever direction (HL) of the lever extends along the second longitudinal direction (L2) and its work arm (LA) is on its end fixed on the first coupling element (K1) such that it can be pivoted about the first longitudinal direction (L1) and
the power arm (KA) of the lever is functionally connected to a third actuator (A3) in such a way that a torque, which acts upon the lever (H) about the pivoting axis (D), can be generated.

2. The device according to claim 1, wherein the coupling component (KK) is arranged axially along the first and/or the second longitudinal direction (L1, L2).

3. The device according to claim 1, wherein at least the first actuator (A1), the first coupling element (K1), the second actuator (A2) and the second coupling element (K2) can be arranged in a common plane (E), and in that the third actuator (A3) is arranged outside this plane (E) and has an effective actuator direction (A3R), which is directed at the power arm (KA) and includes an angle α with the plane (E), wherein
0°<α<90°
applies to said angle.

4. The device according to claim 3, wherein 20°≦α≦65° applies to the angle α.

5. The device according to claim 1, wherein the first, the second and the third actuator (A1, A2, A3) are respectively realized in the form of a linear actuator, namely in the form of a drive from the following group: servo motor, stepping motor, hydraulic cylinder unit, pneumatic cylinder unit.

6. The device according to claim 1, wherein the first actuator (A1) is connected to the first coupling element (K1) by means of a first power transmission mechanism (KM1) and/or that the second actuator (A2) is connected to the second coupling element (K2) by means of a second power transmission mechanism (KM2).

7. The device according to claim 6, wherein the first and the second power transmission mechanisms (KM1, KM2) are respectively realized in the form of a mechanical lever.

8. The device according to claim 1, wherein a linear guide is arranged along the load arm (LA) and varies the length of the load arm.

9. The device according to claim 1, wherein the first and the second coupling element (K1, K2) are realized in the form of rigid longitudinal bodies, namely in the form of a rod, a tube or a longitudinal profile element.

10. The device according to claim 1, wherein the coupling component (KK) is arranged on the end of the first and/or the second coupling element (K1, K2).

11. The device according to claim 1, wherein the first, the second and the third actuator (A1, A2, A3), as well as the pivoting axis (D), are arranged in a spatially fixed fashion.

12. The device according to claim 1, wherein a position determination device is arranged on the coupling component (KK).

13. The device according to claim 1, wherein a force measuring sensor is arranged along the effective actuator directions (A1R, A2R, A3R) and/or on the coupling component (KK).

14. The device according to claim 1, wherein one of the two coupling elements (K1, K2) is realized in the form of a flexural member and the other coupling element is realized in the form of a tension/compression member.

15. The device according to claim 1, wherein both coupling elements (K1, K2) are mounted in such a way that a rotational motion about their longitudinal direction is respectively blocked.

16. An actuator system comprising a plurality of devices according to claim 3, wherein at least two coupling structures (KS1, KS2) are arranged orthogonal to the common planes, which are respectively assigned to these coupling structures, and spaced apart from one another in such a way that the planes (E) of both coupling structures (KS1, KS2) extend parallel to one another.
